(19) United States
(12) Patent Application Publication
(10) Pub. No.: US 2024/0378418 A1
(43) Pub. Date: Nov. 14, 2024

(54) APPARATUS FOR ESTIMATING WHEEL SLIP RATE OF A VEHICLE AND AN APPARATUS FOR ESTIMATING DRIVING SPEED USING THE SAME

(71) Applicants: HYUNDAI MOTOR COMPANY, Seoul (KR); KIA CORPORATION, Seoul (KR); IUCF-HYU (INDUSTRY-UNIVERSITY COOPERATION FOUNDATION HANYANG UNIVERSITY), Seoul (KR)

(72) Inventors: Jun Han Kang, Seoul (KR); Ik Jin Um, Busan (KR); Ji Hun Byun, Hwaseong-si (KR); Man Dong Kim, Hwaseong-si (KR); Jung Ho Park, Incheon (KR); Jin Soo Seo, Suwon-si (KR); Chan Uk Yang, Seoul (KR); Seung Won Choi, Seoul (KR); Hyuk Ju Shon, Seoul (KR); Kun Soo Huh, Seoul (KR)

(73) Assignees: HYUNDAI MOTOR COMPANY, Seoul (KR); KIA CORPORATION, Seoul (KR); IUCF-HYU (INDUSTRY-UNIVERSITY COOPERATION FOUNDATION HANYANG UNIVERSITY), Seoul (KR)

(21) Appl. No.: 18/501,823

(22) Filed: Nov. 3, 2023

(30) Foreign Application Priority Data
May 9, 2023 (KR) 10-2023-0059544

(51) Int. Cl. G06N 3/0442; B60R 16/023

(52) U.S. Cl. CPC G06N 3/0442; B60R 16/0231

(57) ABSTRACT

An apparatus for estimating a vehicle speed includes: a vehicle information receiving unit for receiving driving information of a vehicle, including wheel speed, motor torque, and longitudinal acceleration of the vehicle; a wheel slip determining unit for determining whether wheel slip occurs; a longitudinal acceleration correction unit correcting the longitudinal acceleration received from the vehicle information receiving unit; and a vehicle speed estimation unit for estimating a vehicle speed using the wheel speed or the corrected longitudinal acceleration according to the determination result of the wheel slip determining unit.

### CROSS-REFERENCE TO RELATED APPLICATION(S)

This application claims the benefit of priority to Korean Patent Application No. 10-2023-0059544 filed on May 9, 2023 in the Korean Intellectual Property Office, the disclosure of which is incorporated herein by reference in its entirety.

### BACKGROUND

### 1. Technical Field

The present disclosure relates to an apparatus for estimating the wheel slip rate of a vehicle and an apparatus for estimating a driving speed using the same.

### 2. Description of Related Art

Recently, driving on off-road surfaces such as sand, mud, and gravel has been increasing in popularity. In addition, interest in off-road vehicles is increasing as vehicle orders increase in many overseas countries where off-road surfaces are the main part of the country.

Conversely, on an off-road surface, slippage of wheels frequently occurs. The wheels may be in a state in which the vehicle cannot move due to the resistance of the road surface, for example, a vehicle may get stuck. For this reason, it is difficult to accurately estimate off-road wheel slip rate while wheel slip rate and driving speed estimation is used in general vehicles.

An example of a related art technique for calculating a wheel slip rate is described in a Korean patent publication, ‘Vehicle Slip Rate Calculator’ (Application No.: 10-2003-0101251, hereinafter, referred to as ‘the related art’). Referring to the vehicle slip rate calculator of the related art, a method of calculating a vehicle speed is disclosed using an acceleration sensor and an angular velocity sensor installed in the vehicle and thereby calculating a wheel slip rate.

Conversely, the method disclosed in the related art may determine a relatively accurate slip rate because less noise is generated in the sensor on a flat road surface. However, on an off-road surface, not only does the slope of the road surface continuously change, but also substantial noise is generated in the sensor value due to random irregularities on the road surface. Thus, in the method disclosed in the related art, it may be difficult to determine an accurate wheel slip rate.

It may be difficult to determine an accurate wheel slip rate when a four-wheel drive-type vehicle drives off-road. In a front or rear-wheel drive type vehicle, wheel slip occurs in a wheel that drives and transmits force to a road surface. Accordingly, in a front or rear-wheel drive type vehicle, the wheel slip rate may be calculated by estimating the average speed calculated from the remaining non-driving wheels at which wheel slip does not occur, as the vehicle speed.

However, since most off-road vehicles are designed with four-wheel drive and all four wheels are used for driving, wheel slip may occur at all four wheels. Therefore, when the average of the vehicle speeds calculated for respective wheels is used, there is a problem in that a large error in vehicle speed may occur due to the speed calculated for any wheel with wheel slip.

Therefore, there is a need for a technology in which the driving speed of a vehicle may be accurately estimated even in a four-wheel drive type off-road vehicle.

### SUMMARY

An aspect of the present disclosure is to provide a device in which a wheel slip rate of a vehicle traveling off-road may be accurately estimated.

Another object of the present disclosure is to provide a device in which the driving speed of a vehicle traveling off-road may be accurately estimated.

According to an aspect of the present disclosure, an apparatus for estimating wheel slip rate includes a storage unit storing a wheel slip estimation model and includes a wheel slip estimation unit that estimates wheel slip information using the wheel slip estimation model based on driving information.

The driving information may include at least one of engine torque, a number of revolutions per minute (RPM) of an engine, longitudinal acceleration, lateral acceleration, a yaw-rate, and a wheel rotation speed of each wheel.

The wheel slip estimation model may be learned using a deep learning network.

The wheel slip estimation model may be learned using a Long-Short Term Memory (LSTM) network.

In the wheel slip estimation model, at least one of a smooth L1 loss function or a Gaussian negative log likelihood (NLL) loss function may be applied as a loss function.

The wheel slip estimation model may be learned by applying a wheel slip rate determined using a global positioning system (GPS) as a correct value.

According to another aspect of the present disclosure, an apparatus for estimating a driving speed includes a receiving unit acquiring driving information of a vehicle and a storage unit storing a wheel slip estimation model. The apparatus also includes a wheel slip estimation unit that estimates wheel slip information using the wheel slip estimation model based on the driving information. The apparatus also includes a driving speed estimation unit that estimates a driving speed of the vehicle based on the wheel slip information.

The receiving unit may receive the driving information using a network provided in the vehicle.

The driving information may include at least one of engine torque, engine speed, longitudinal acceleration, lateral acceleration, a yaw-rate, and/or a wheel rotation speed of each wheel.

The wheel slip estimation model may be learned using a deep learning network.

The apparatus for estimating a driving speed may further include a pre-processing unit that receives and pre-processes the driving information from the receiving unit. The pre-processing unit may transmit the driving information to the wheel slip estimation unit.

The pre-processing unit may pre-process the driving information received, using standardization.

The wheel slip information may include an average and a variance of wheel slip rates.

The driving speed estimation unit may estimate a driving speed for each wheel provided in the vehicle. The driving speed estimation unit may also estimate the driving speed of the vehicle by applying a weight to the driving speed estimated for each wheel.

The driving speed estimation unit may differently apply a method of estimating the driving speed, based on a magnitude of a wheel slip rate estimated by the wheel slip estimation unit, in estimating the driving speed for each wheel.

The driving speed estimation unit may determine a weight of the driving speed estimated for each wheel, based on a variance value estimated by the wheel slip estimation unit.

The apparatus for estimating a driving speed may further include a post-processing unit that post-processes wheel slip rate information estimated by the wheel slip estimation unit and the driving speed estimated by the driving speed estimation unit.

The post-processing unit may fix the driving speed and the wheel slip rate to ‘0’ (zero) when a product of a wheel rotational angular velocity and a dynamic radius of each wheel is a preset value or less.

The post-processing unit may post-process the driving speed using an exponential moving average.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a block diagram of an apparatus for estimating wheel slip rate and for estimating a driving speed using the same according to an embodiment;

FIG. 2 is a block diagram of an apparatus for estimating wheel slip rate according to an embodiment;

FIG. 3 is a block diagram illustrating a learning process of a wheel slip estimation model according to an embodiment;

FIG. 4 is a block diagram illustrating a process of estimating a driving speed of a vehicle according to an embodiment; and

FIG. 5 is a graph illustrating an estimated driving speed, an average driving speed calculated for each wheel, and a driving speed calculated from a global positioning system (GPS) according to an embodiment.

### DETAILED DESCRIPTION

Since the present disclosure may be variously change and have various embodiments, some embodiments are illustrated in the drawings and described in detail. However, this is not intended to limit the present disclosure to the described embodiments and should be understood to include all modifications, equivalents, and substitutes included in the spirit and scope of the present disclosure.

Terms such as first and second may be used to describe various components, but the components should not be limited by the terms. These terms are only used for distinguishing one component from another. For example, a first element may be termed a second element, and similarly, a second element may be termed a first element, without departing from the scope of the present disclosure. The use of ‘and/or’ includes any combination of a plurality of related recited items or any one of a plurality of related recited items.

Terms used in this application are only used to describe embodiments and are not intended to limit the present disclosure. Singular expressions include plural expressions unless the context clearly dictates otherwise. In this application, the terms “include”, “have” and the like, and variations thereof, are intended to designate that there is a feature, number, step, operation, component, part, or combination thereof described in the specification. But it should be understood that these terms do not preclude the possibility of the presence or addition of one or more other features, numbers, steps, operations, components, parts, or combinations thereof.

Unless defined otherwise, all terms used herein, including technical or scientific terms, have the same meaning as commonly understood by one of ordinary skill in the art to which the present disclosure pertains. Terms such as those defined in commonly used dictionaries should be interpreted as having a meaning consistent with the meaning in the context of the related art and, unless expressly defined in this application, it is not to be construed in an ideal or overly formal sense.

Hereinafter, with reference to the accompanying drawings, embodiments of the present disclosure are described in more detail. When a component, device, element, unit, or the like, of the present disclosure, is described as having a purpose or performing an operation, function, or the like, the component, device, element, or unit should be considered herein as being “configured to” meet that purpose or to perform that operation or function. Further, each the component, device, element, unit, and the like may separately embody or be included with a processor and a memory, such as a non-transitory computer readable media, as part thereof.

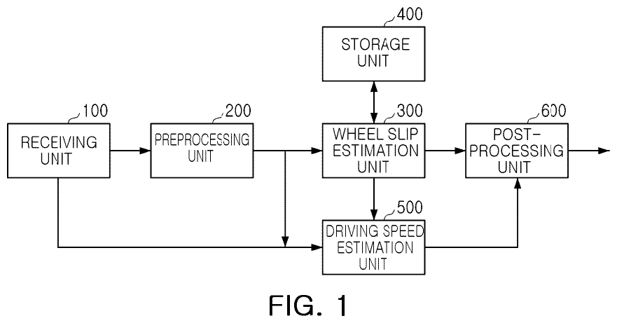

FIG. 1 is a block diagram of an apparatus for estimating wheel slip rate and for estimating a driving speed using the same according to an embodiment.

Referring to FIG. 1, an apparatus for estimating wheel slip rate may include a storage unit 400 and a wheel slip estimation unit 300. In addition, an apparatus for estimating the driving speed of a vehicle may include a receiving unit 100, an apparatus for estimating wheel slip rate, and a driving speed estimation unit 500.

The receiving unit 100 may receive information about the driving state of the vehicle. For example, the receiving unit 100 may receive engine revolutions per minute (RPM), engine torque, longitudinal acceleration, lateral acceleration, yaw rate, wheel speed of each wheel, and the like, in Controller Area Network (CAN) signals of the vehicle.

The receiving unit 100 may receive information about the driving state of the vehicle using a network provided in the vehicle. For example, the receiving unit 100 may receive driving state information, such as engine RPM, engine torque, longitudinal acceleration, lateral acceleration, yaw rate, and wheel speed of each wheel, using the vehicle's CAN network.

The receiving unit 100 may be time-series data of vehicle driving information collected for a preset time period. In addition, the receiving unit 100 may generate time-series data of a preset number of times (e.g., 30 times) at preset time intervals (e.g., 20 milliseconds). A preset time interval may be referred to as a sampling time, and a preset number of times may be referred to as a window size.

Table 1 illustrates the results of testing the performance according to the window size and sampling time in the apparatus for estimating wheel slip rate and the apparatus for estimating a driving speed using the same according to an embodiment.

TABLE 1

| | | | Window Size [samples] | | | | |
|---|---|---|---|---|---|---|---|
| | | | 10 | 20 | 30 | 40 | 50 |
| Sampling | 10 | MAE [%] | 2.05 | 1.91 | 1.78 | 1.67 | 1.91 |
| Time | | RMSE [%] | 3.75 | 3.52 | 3.58 | 3.17 | 3.52 |
| [ms] | 20 | MAE [%] | 1.95 | 1.77 | 1.69 | 1.66 | 1.64 |
| | | RMSE [%] | 3.58 | 3.41 | 3.21 | 3.21 | 3.12 |
| | 50 | MAE [%] | 1.94 | 1.80 | 1.84 | 1.76 | 1.81 |
| | | RMSE [%] | 3.62 | 3.41 | 3.49 | 3.49 | 3.41 |
| | 100 | MAE [%] | 2.07 | 1.98 | 1.82 | 1.94 | 1.86 |
| | | RMSE [%] | 3.61 | 3.73 | 3.47 | 3.69 | 3.59 |

The mean absolute error (MAE) may be an average of absolute values of errors between the actual model and the estimation model. The average absolute error may be evaluated as having a smaller error as the average error is smaller. Furthermore, the average performance of the estimation model may be intuitively grasped.

In addition, the root mean square error (RMSE) may be the square root of an average value of squares of errors between the actual model and the estimation model. Like the mean absolute error, the smaller the root mean square error is, the smaller the error may be evaluated.

In addition, according to the preliminary test, when the sampling time was 10 milliseconds (ms), the wheel slip estimation time was excessive in all window sizes. Even when the sampling time was 50 ms and the window sizes were 40 and 50 samples, the estimation time was similarly long. In an embodiment of the present disclosure, a sampling time of 20 ms and a window size of 30 samples may be applied in consideration of the accuracy and wheel slip estimation time illustrated as an example in Table 1. In an apparatus for estimating wheel slip rate and for estimating a driving speed using the same according to an embodiment of the present disclosure, the sampling time is set to 50 ms and the window size is set to 30 samples. Therefore, the accuracy of the estimated value may be guaranteed and the estimation time may be reduced. However, the window size and sampling time may be applied in various manners depending on the specifications of the embedded personal computer (PC) or processor applied to the apparatus for estimating wheel slip rate and the apparatus for estimating a driving speed using the same, and depending on the applied deep learning model.

Referring back to FIG. 1, a preprocessing unit 200 may perform a predetermined conversion to input the input data received through the receiving unit 100 to the wheel slip estimation unit 300 to be described later. For example, the preprocessing unit 200 may pre-process the input data received through the receiving using a unit 100 standardization method.

Methods for preprocessing the input data by the preprocessing unit 200 may include normalization and standardization. The normalization may be a preprocessing of converting the input data between 0 and 1 by changing to the difference between each value and a minimum value in comparison with the difference between the maximum value and the minimum value of the input data. In addition, the standardization may be preprocessing that transforms input data into a normal distribution with a mean of 0 and a standard deviation of 1.

The results of testing the performance of the apparatus for estimating wheel slip rate and for estimating a driving speed using the apparatus for estimating wheel slip rate according to an embodiment with different preprocessing methods are illustrated in Table 2 below.

TABLE 2

| Performance | No | | |
|---|---|---|---|
| Indicator | Preprocessing | Normalization | Standardization |
| MAE | Unable to train | 3.06[%] | 2.77[%] |
| RMSE | | 4.78[%] | 4.39[%] |
| R2 | | 0.760[—] | 0.798[—] |

The coefficient of determination (R2 score) may indicate how much the estimation model correlates with the actual model. The R2 score may also be a ratio of the variance of the predicted value compared to the variance of the actual value. The closer the coefficient of determination is to 1, the more accurate the model may be. The closer the coefficient of determination is to 0, the less accurate the model may be.

Referring to Table 1 again, it is impossible to learn the wheel slip estimation unit 300 without preprocessing. It can be confirmed that the case in which standardization is applied as a preprocessing method has higher reliability than the case in which normalization is applied.

The storage unit 400 may store a wheel slip estimation model 310 composed of an artificial neural network for which learning has been completed. The artificial neural network may be implemented based on a long-short term memory (LSTM) as described below.

The storage unit 400 is a recording medium suitable for storing the wheel slip estimation model 310. For example, the storage unit 400 may include magnetic media, such as hard disks, floppy disks and magnetic tapes, optical media such as Compact Disk Read Only Memory (CD-ROM) and Digital Video Disk (DVD), magneto-optical media, such as floptical disks, and/or semiconductor memories, such as flash memory or Erasable Programmable ROM (EPROM) or solid-state drives (SSDs) based thereon.

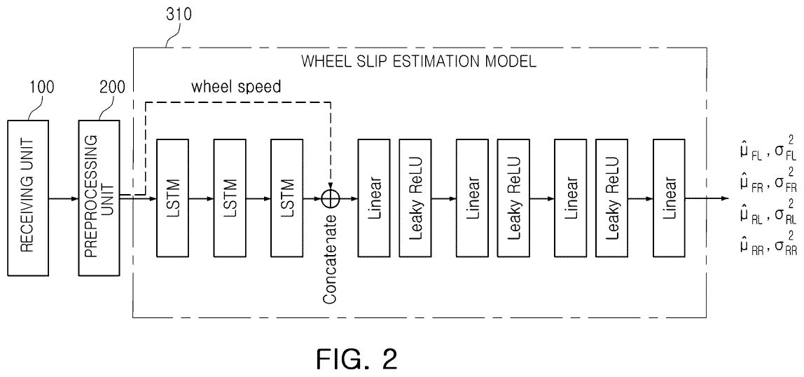

The wheel slip estimation unit 300 may estimate the wheel slip rate, and a variance value thereof, for each wheel of the vehicle in motion using the wheel slip estimation model (310 in FIG. 2) stored in the storage unit 400.

The driving speed estimation unit 500 may estimate the driving speed using the wheel slip rate estimated by the wheel slip estimation unit 300 and the variance value of the wheel slip rate.

The wheel slip estimation unit 300 and the driving speed estimation unit 500 may be implemented through a non-volatile memory (not illustrated) and a processor (not illustrated). The non-volatile memory may be configured to store data relating to algorithms configured to control the operation of various components of the vehicle or software instructions for reproducing the algorithms. The processor may be configured to perform an operation described below using data stored in a corresponding memory. The memory and the processor may be implemented as individual chips. Alternatively, the memory and processor may be implemented as a single chip integrated with each other. A processor may have the form of one or more processors.

A post-processing unit 600 may post-process data estimated by the wheel slip estimation unit 300 and the driving speed estimation unit 500.

The post-processing unit 600 may limit the amount of change in the estimated data to prevent a phenomenon in which the estimated data changes rapidly. For example, the post-processing unit 600 may limit the amount of change such that the wheel slip rate estimated by the wheel slip estimation unit 300 does not exceed 100%/s. In addition, the post-processing unit 600 may limit the change in the driving speed estimated by the driving speed estimation unit 500, for example, the traveling acceleration, from exceeding a set value (e.g., 4.9 m/s\hat{ }2). Therefore, required data may be stably estimated by preventing a phenomenon in which data rapidly bounces due to an operation error, external noise or the like.

In addition, since wheel slip estimation may be estimated only when the vehicle is running, accurate estimation cannot be performed because learning cannot be performed for a state in which the vehicle is stopped. Accordingly, the wheel slip rate and driving speed may be set to be zero when the vehicle is stopped. The stopped state of the vehicle may be determined based on the product of the rotational angular velocity of the wheel and the dynamic radius. For example, when the largest value of the product of the rotational angular velocity of the wheel and the dynamic radius calculated from the wheel mounted on the vehicle is the set value (e.g., 0.36 km/h (kilometers per hour)) or less, it may be determined that the vehicle is in a stopped state.

The post-processing unit 600 may set a lower limit value of the wheel slip rate and an upper limit value of the driving speed. Referring to Equation 5 described below, when the wheel slip rate estimated by the wheel slip estimation unit 300 is estimated to be close to −100%, the estimated value of the driving speed may diverge. When the estimated driving speed diverges, the braking control unit of the vehicle may rapidly brake, and the possibility of getting stuck may greatly increase.

In addition, according to the results of analyzing the actual experimental data, the wheel slip rate has a negative value only in a low-speed condition, i.e., section of when the driving speed is 2 km/h or less. The negative value of the wheel slip rate may not have a significant effect on the actual vehicle driving speed estimation.

Accordingly, the post-processing unit 600 may apply the lower limit value of the wheel slip rate estimated by the wheel slip estimation unit 300 in the process of calculating the driving speed of the vehicle. For example, when the wheel slip rate estimated by the wheel slip estimation unit 300 is less than or equal to a set value (e.g., −25%), in estimating the driving speed, a wheel slip rate may be applied as a set value (e.g., −25%). Similarly, for the driving speed estimated by the driving speed estimation unit 500, the post-processing unit 600 may apply the upper limit value of the set value (e.g., 1.33 times) of the wheel speed calculated by the product of the rotational angular speed of the wheel and the dynamic radius.

In addition, the post-processing unit 600 may estimate the driving speed and the wheel slip rate in a different manner under a preset low-speed condition to prevent divergence of the wheel slip rate and the driving speed in low-speed situations. This is to prevent the occurrence of a large error due to a time delay between a driving speed and a wheel speed estimated through a global positioning system (GPS) under a low-speed condition. The preset low-speed condition may be a condition in which the wheel speed calculated as the product of the rotational angular velocity of the wheel and the dynamic radius is equal to or less than a first set value (e.g., 1.5 km/h). Among the wheels provided in the vehicle, the difference between a wheel speed calculated for the wheel with a maximum wheel speed and a wheel speed calculated for the wheel with a lowest wheel speed, calculated as the product of the rotational angular velocity and the dynamic radius of the wheel, is within a second set value (e.g., 0.36 km/h).

Also, the post-processing unit 600 may use an exponential moving average (EMA). The exponential moving average (EMA) may be a moving average that gives greater weight and significance to the most recent data points.

Components of the apparatus for estimating a driving speed may exchange information by being wired or wirelessly connected using a network provided in the vehicle. For example, the components of the apparatus for estimating a driving speed may exchange data using the network communication means provided in the vehicle, for example, Ethernet, Media Oriented Systems Transport (MOST), Flexray, Controller Area Network (CAN), Local Interconnect Network (LIN), Internet, Long Term Evolution (LTE), 5G, Wi-Fi, Bluetooth, Near Field Communication (NFC), Zigbee, Radio Frequency (RF), or the like.

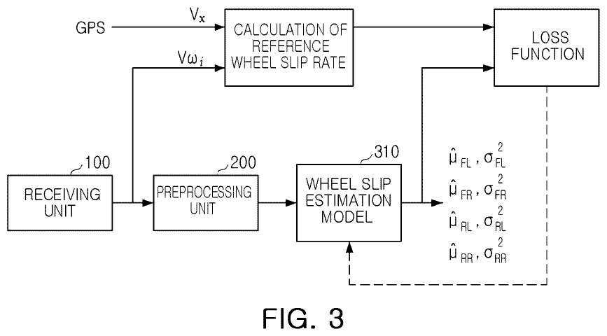

FIG. 2 is a block diagram of an apparatus for estimating wheel slip rate according to an embodiment. FIG. 3 is a block diagram illustrating a learning process of a wheel slip estimation model 310 according to an embodiment.

Referring to FIG. 2, the wheel slip estimation model 310 according to an embodiment encodes input data using LSTM and decodes the data through a linear layer to estimate the wheel slip rate of each wheel and variance values. Wheel speed information may be prevented from being lost by the wheel slip estimation model 310, using skip connection. In more detail, the wheel slip estimation model 310 may prevent wheel speed information from being lost by combining an encoded signal and a wheel speed signal before encoding, using LSTM. In addition, LSTM used for encoding may be comprised of three layers. A linear layer used for decoding may be formed of four layers and may further include an activation function between respective linear layers. The activation function may add nonlinearity to the output data. The activation function according to an embodiment of the present disclosure may be a leaky rectified linear unit (ReLU).

The LSTM, skip connection, linear layer, and activation function itself are well-known technologies, and detailed descriptions thereof have been omitted.

Referring to FIG. 3, a process of learning the wheel slip estimation model 310 according to an embodiment is illustrated as an example. The wheel slip estimation model 310 may be learned by comparing a value calculated using GPS with a value calculated by the wheel slip estimation model 310. In more detail, deep learning may be performed on the value calculated using GPS and the value estimated by the wheel slip estimation model 310 through error backpropagation.

The wheel slip estimation model 310 may calculate the wheel slip rate based on the product of the rotational angular velocity of the wheel and the dynamic radius of the wheel input through the receiving unit 100 and the speed value received from the GPS. A wheel slip rate calculated using GPS may be referred to as a reference wheel slip rate. An equation for calculating the reference wheel slip rate may be the same as Equation 1. The reference wheel slip rate may be applied as a correct value in the deep learning process of the wheel slip estimation model 310 to train the wheel slip estimation model 310.

$${λ}_{i} = \{ \begin{matrix}0 & \begin{matrix}if {V}_{x} \leq 1.5 m / s and \\ \vert {V}_{x} - R {ω}_{i} \vert \leq 0.36 m / s\end{matrix} \\ \frac{R {ω}_{i} - {V}_{x}}{max ( {V}_{x} , R {ω}_{i} , ∈ )} & otherwise\end{matrix} \qquad [ Equation 1 ]$$

In Equation 1, λ is the wheel slip rate, Vₓ is the longitudinal speed (km/h) of the vehicle measured by GPS, R is the dynamic radius of the wheel including the tire, ω is the rotational angular velocity of the wheel, and ε may be a non-zero constant as a threshold value. Also, i may refer to each wheel provided in the vehicle. For example, for a four-wheel drive vehicle, to respectively distinguish the left front wheel (FL), the right front wheel (FR), the left rear wheel (RL), and the right rear wheel (RR), i may be distinguished by setting different i values. In addition, the product Rωᵢ of the dynamic radius of the wheel including the tire and the rotational angular velocity of the wheel may be referred to as the wheel speed. In addition, by defining ε as a non-zero positive constant, ε may be a value for preventing divergence of the wheel slip rate when Vₓ and Rωᵢ, which are located in the denominator of the equation for calculating the wheel slip rate, have a value of 0.

In addition, in the low-speed section, since a large time delay between Vₓ and Rωᵢ is observed, there is a problem in which a large error occurs. Therefore, in the low-speed section, Vₓ may be applied as 0. The low-speed section may refer to a section in which the wheel speed is less than or equal to the first set value (e.g., 1.5 km/h) and the difference between a maximum wheel speed and a minimum wheel speed, calculated from the wheels installed in the vehicle, is less than or equal to the second set value (e.g., 0.36 km/h).

According to an embodiment of the present disclosure, when the wheel speed is faster than the driving speed of the vehicle, positive (+) slip may occur. Conversely, when the driving speed of the vehicle is faster than the wheel speed, negative (−) slip may occur.

Referring back to FIG. 3, the wheel slip estimation model 310 may perform error back-propagation learning using a loss function. As in an example illustrated in Equation 2, the wheel slip estimation model 310 may be formed of a combination of a smooth L1 loss function and a Gaussian negative log likelihood loss function, as a loss function.

$$L = {l}_{L 1} + α {l}_{NLL} \qquad [ Equation 2 ]$$

In Equation 2, L may be a loss function, l_{L1} may be a smooth L1 loss function, and l_{NLL} may be a gaussian NLL loss function.

The smooth L1 loss function (l_{L1}) may be adjusted such that the wheel slip rate estimated by the wheel slip model may estimate a value similar to the wheel slip rate derived using GPS, for example, the reference wheel slip rate. The smooth L1 loss function may be represented as the following equation, Equation 3.

$${l}_{L 1} = \{ \begin{matrix}\frac{0.5 {( {\hat{μ}}_{i} - {λ}_{i} )}^{2}}{β} , if \vert {\hat{μ}}_{i} - {λ}_{i} \vert < β \\ \vert {\hat{μ}}_{i} - {λ}_{i} \vert - 0.5 * β , otherwise\end{matrix} \qquad [ Equation 3 ]$$

In addition, as illustrated in Equation 4 as an example, the Gaussian negative log likelihood loss function (l_{NLL}) may learn the average and variance values of the slip rate by learning the distribution of data.

$${l}_{NLL} = \frac{1}{2} ( log ( max ( {σ}^{2} , ϵ ) + \frac{{( {\hat{μ}}_{i} - {λ}_{i} )}^{2}}{max ( {σ}^{2} , ϵ )} ) \qquad [ Equation 4 ]$$

In Equation 4, L may be a loss function, (l_{L1}) may be a smooth L1 loss function, and (l_{NLL}) may be a gaussian NLL loss function. In Equations 3 and 4, (λᵢ) is the reference wheel slip rate calculated as in Equation 1 based on the GPS signal, (û) is the wheel slip rate estimated by the wheel slip estimation unit 300, and (σ²) is the variance value estimated by the wheel slip estimation unit 300. Also, (ε) and (β) are non-zero constants.

Referring back to FIG. 3, the wheel slip estimation model 310 may perform error back-propagation learning, using the wheel slip rate estimated by the wheel slip estimation model 310 and a reference wheel slip rate calculated from GPS.

The wheel slip estimation model 310 learned through the above process may be stored in the storage unit 400. The wheel slip estimation unit 300 may estimate the wheel slip rate and variance value, using the wheel slip estimation model 310 stored in the storage unit 400.

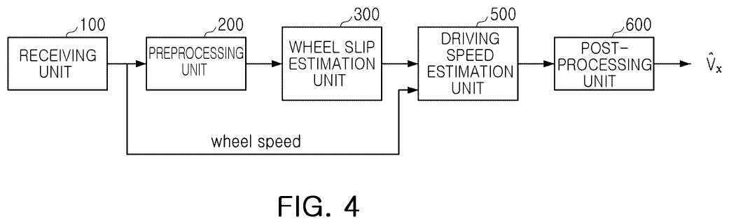

FIG. 4 is a block diagram illustrating a process of estimating the driving speed of a vehicle according to an embodiment.

Referring to FIG. 4 together with FIG. 1, the driving speed estimation unit 500 may estimate the driving speed (\hat{V}_{x,i}) in different manners according to the wheel slip rate. When the wheel slip rate is less than the set value (e.g., 0), the driving speed estimation unit 500 estimates the driving speed through Equation 5. When the wheel slip rate is greater than or equal to the set value (e.g., 0), the driving speed estimation unit 500 may estimate the driving speed (\hat{V}_{x,i}) of each wheel provided in the vehicle by Equation 6.

$${\hat{V}}_{x , i} = \frac{R {ω}_{i}}{{λ}_{i} + 1} \qquad [ Equation 5 ]$$

$${\hat{V}}_{x , i} = ( 1 - {λ}_{i} ) R {ω}_{i} \qquad [ Equation 6 ]$$

The driving speed estimation unit 500 may estimate the driving speed of the vehicle based on the driving speed estimated for each wheel. In more detail, the driving speed of the vehicle may be calculated by multiplying the weight of each wheel calculated by the ratio of the driving speed estimated for respective wheels and then summing the same.

The calculation of the driving speed (\hat{V}ₓ₁) of the vehicle may be expressed as Equation 7 below, the equation for calculating the weight (ωᵢ) may be expressed as Equation 8. The driving speed of the vehicle estimated based on Equation 7 may be referred to as a first driving speed to be distinguished from the driving speed of the vehicle in a low-speed condition to be described later.

$${\hat{V}}_{x 1} = {\sum }_{i = 1}^{4} {w}_{i} {\hat{V}}_{x , i} \qquad [ Equation 7 ]$$

$${w}_{i} = ( \frac{1}{{σ}_{i}^{2} + ϵ} ) / {\sum }_{i = 1}^{4} ( \frac{1}{{σ}_{i}^{2} + ϵ} ) \qquad [ Equation 8 ]$$

In addition, during low-speed driving, to prevent occurrence of the problem that the driving speed estimated from the driving speed estimation unit 500 has a large error with the driving speed determined from the GPS, the driving speed estimation unit 500 may use a different method of estimating the driving speed in a low-speed condition.

In more detail, the driving speed estimation unit 500 may estimate the driving speed (\hat{V}ₓ₂) according to Equation 9 and estimate the wheel slip rate (λᵢ) according to Equation 10 under the low-speed condition. The low-speed condition may be a condition in which, in the low-speed section, the wheel speed is less than or equal to the first set value (e.g., 1.5 km/h). The difference between a maximum wheel speed and a minimum wheel speed calculated from the wheels provided in the vehicle is the second set value (0.36 km/h) or less. In addition, the driving speed of the vehicle estimated under the low-speed condition may be referred to as a second driving speed to be distinguished from the aforementioned first driving speed.

$${\hat{V}}_{x 2} = \frac{1}{4} {\sum }_{i = 1}^{4} R {ω}_{i} \qquad [ Equation 9 ]$$

$${λ}_{i} = \frac{R {ω}_{i} - {\hat{V}}_{x 2}}{max ( {\hat{V}}_{x 2} , R {ω}_{i} , ϵ )} \qquad [ Equation 10 ]$$

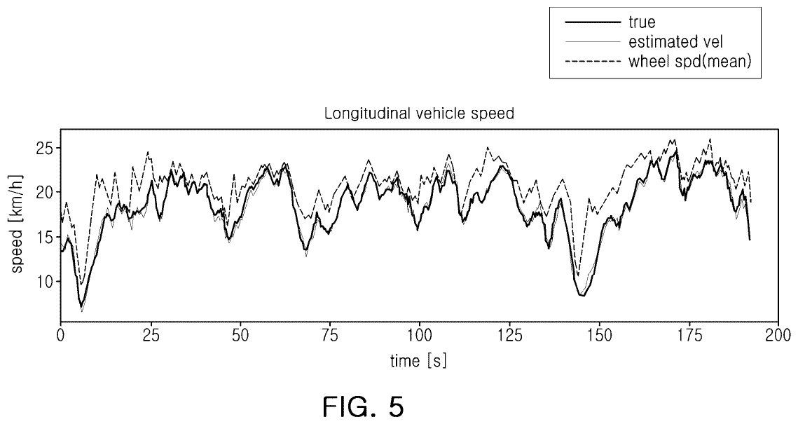

FIG. 5 is a graph illustrating the estimated driving speed, the average driving speed calculated from each wheel, and the driving speed calculated from GPS according to an embodiment.

Referring to FIG. 5, the driving speed that may be checked through GPS is expressed as a ‘true’ line. The driving speed using the average of the wheel speeds of respective wheels provided in the vehicle according to the related art is expressed as a ‘wheel spd (mean)’ diagram. The estimated driving speed according to an embodiment of the present disclosure is expressed as ‘estimated vel’.

As illustrated in FIG. 5 as an example, the estimated speed according to an embodiment of the present disclosure has less error with the actual driving speed that may be checked through GPS, as compared to the speed estimated according to the related art. For example, it can be confirmed that the estimation speed according to an embodiment of the present disclosure has improved accuracy, compared to the related art technique.

The methods according to embodiments of the present disclosure may be implemented in the form of program instructions that may be executed by various computer means and may be recorded on a computer readable medium. Computer readable media may include program instructions, data files, data structures, and the like alone or in combination. Program instructions recorded on a computer readable medium may be designed and configured for the present disclosure or may be known to and usable by those of ordinary skill in the art of computer software.

Examples of computer readable media include hardware devices specially configured to store and execute program instructions, such as read-only memory (ROM), random-access memory (RAM), flash memory, and the like. Examples of program instructions include high-level language codes that may be executed by a computer using an interpreter or the like as well as machine language codes generated by a compiler. The hardware device described above may be configured to operate as at least one software module to perform the operations in the present disclosure, and vice versa.

As set forth above, according to an embodiment, a wheel slip rate of a vehicle traveling off-road may be accurately estimated using a deep-learned wheel slip estimation model.

In addition, the driving speed of a vehicle traveling off-road may be accurately estimated by using the wheel slip rate of the vehicle. The wheel slip rate and the driving speed may be accurately estimated in the same device or apparatus or in separate devices or apparatuses.

While example embodiments have been illustrated and described above, it should be apparent to those of ordinary skill in the art that modifications and variations could be made without departing from the scope of the present disclosure as defined by the appended claims.

What is claimed is:

1. An apparatus for estimating wheel slip rate, the apparatus comprising:
a storage unit storing a wheel slip estimation model; and
a wheel slip estimation unit estimating wheel slip information using the wheel slip estimation model based on driving information.

2. The apparatus of claim 1, wherein the driving information includes at least one of an engine torque, a number of revolutions per minute (RPM) of an engine, a longitudinal acceleration, a lateral acceleration, a yaw-rate, and a wheel rotation speed of each wheel.

3. The apparatus of claim 1, wherein the wheel slip estimation model is learned using a deep learning network.

4. The apparatus of claim 3, wherein the wheel slip estimation model is learned using a Long-Short Term Memory (LSTM) network.

5. The apparatus of claim 4, wherein the LSTM network has a sampling time of 20 milliseconds and a window size of 30 samples.

6. The apparatus of claim 1, wherein, in the wheel slip estimation model, at least one of a smooth L1 loss function and a Gaussian negative log likelihood (NLL) loss function is applied as a loss function.

7. The apparatus of claim 1, wherein the wheel slip estimation model is learned by applying a wheel slip rate determined using a global positioning system (GPS) as a correct value.

8. An apparatus for estimating a driving speed, comprising:
a receiving unit acquiring driving information of a vehicle;
a storage unit storing a wheel slip estimation model;
a wheel slip estimation unit estimating wheel slip information using the wheel slip estimation model based on the driving information; and
a driving speed estimation unit estimating a driving speed of the vehicle based on the wheel slip information.

9. The apparatus of claim 8, wherein the receiving unit receives the driving information using a network provided in the vehicle.

10. The apparatus of claim 8, wherein the driving information includes at least one of an engine torque, an engine speed, a longitudinal acceleration, a lateral acceleration, a yaw-rate, and a wheel rotation speed of each wheel.

11. The apparatus of claim 8, wherein the wheel slip estimation model is learned using a deep learning network.

12. The apparatus of claim 8, further comprising a pre-processing unit configured to receive and pre-process the driving information from the receiving unit, and then to transmit the driving information to the wheel slip estimation unit.

13. The apparatus of claim 12, wherein the pre-processing unit is configured to pre-process the driving information received, using standardization.

14. The apparatus of claim 8, wherein the wheel slip information includes an average and a variance of wheel slip rates.

15. The apparatus of claim 8, wherein the driving speed estimation unit is configured to:
estimate a driving speed for each wheel provided in the vehicle; and
estimate the driving speed of the vehicle by applying a weight to the driving speed estimated for each wheel.

16. The apparatus of claim 15, wherein the driving speed estimation unit is configured to differently apply a method of estimating the driving speed based on a magnitude of a wheel slip rate estimated by the wheel slip estimation unit, in estimating the driving speed for each wheel.

17. The apparatus of claim 15, wherein the driving speed estimation unit is configured to determine a weight of the driving speed estimated for each wheel, based on a variance value estimated by the wheel slip estimation unit.

18. The apparatus of claim 8, further comprising a post-processing unit configured to post-process wheel slip rate information estimated by the wheel slip estimation unit and the driving speed estimated by the driving speed estimation unit.

19. The apparatus of claim 18, wherein the post-processing unit is configured to fix the driving speed and the wheel slip rate to ‘0’ (zero) when a product of a wheel rotational angular velocity and a dynamic radius of each wheel is a preset value or less.

20. The apparatus of claim 18, wherein the post-processing unit is configured to post-process the driving speed using an exponential moving average.
